(19) United States
(12) Patent Application Publication
(10) Pub. No.: US 2025/0263123 A1
(43) Pub. Date: Aug. 21, 2025

(54) Steering System, Vehicle Comprising the Steering System, Method for Operating Steering System

(71) Applicant: Robert Bosch GmbH, Stuttgart (DE)

(72) Inventor: Roland Greul, Schwaebisch Gmuend (DE)

(21) Appl. No.: 19/041,034

(22) Filed: Jan. 30, 2025

(30) Foreign Application Priority Data
Feb. 15, 2024 (DE) 10 2024 201 409.5

(51) Int. Cl. B62D 15/02; B62D 5/00; B62D 5/04

(52) U.S. Cl. CPC B62D 15/0235; B62D 5/046; B62D 5/001

(57) ABSTRACT

A steering system includes a control element for detecting an angle of rotation and a torque, and a steering actuator for moving steered wheels of the vehicle as a function of a desired steering angle. It is determined whether the angle of rotation lies in a first angle range or a second angle range that is different from the first angle range. The desired steering angle in the first angle range of the angle of rotation is determined as a function of the angle of rotation. The desired steering angle steering angle in the second angle range of the angle of rotation is determined as a function of the torque. The first angle range comprises the angle of rotation which is associated with the desired steering angle for the vehicle travelling in a straight line.

This application claims priority under 35 U.S.C. § 119 to patent application no. DE 10 2024 201 409.5, filed on Feb. 15, 2024 in Germany, the disclosure of which is incorporated herein by reference in its entirety.

### BACKGROUND

The disclosure is based on a steering system, a vehicle comprising the steering system, and a method for operating the steering system.

Such a steering system can be operated by a driver using a control element. The control element can be used to provide the driver with driver feedback.

### SUMMARY

The steering system and the method for operating the steering system of a vehicle provide driver feedback via a steering system control element that is effective even when the angle range of the control element is small.

The method comprises the steering system comprising a control element for detecting an angle of rotation, wherein a torque applied by the control element is detected or provided, wherein the steering system comprises a steering actuator for moving steered wheels of the vehicle as a function of a desired steering angle, wherein determining whether the angle of rotation lies in a first angle range or a second angle range that is different from the first angle range, wherein the desired steering angle in the first angle range of the angle of rotation is determined as a function of the angle of rotation, wherein the desired steering angle in the second angle range of the angle of rotation is determined as a function of the torque, wherein the first angle range comprises the angle of rotation which is associated with the desired steering angle for travelling in a straight line or essentially travelling in a straight line of the vehicle, wherein the second angle range comprises an angle of rotation which is associated with a desired steering angle for a maximum steering lock of the steered wheels.

Preferably, it is determined that the angle of rotation lies in the first angle range if the angle of rotation or an amount of the angle of rotation is smaller than a threshold value, in particular 50°, or it is determined that the angle of rotation lies in the first angle range if the angle of rotation or an amount of the angle of rotation is smaller than or equal to a threshold value, in particular 50°.

Preferably, it is determined that the angle of rotation lies in the second angle range if the angle of rotation or an amount of the angle of rotation is greater than or equal to a threshold value, in particular 50°, or it is determined that the angle of rotation lies in the second angle range if the angle of rotation or an amount of the angle of rotation is greater than a threshold value, in particular 50°.

Preferably, the control element is used to detect an angle of rotation between −60° and 60°, wherein the first angle range comprises angles of rotation between −50° and 50°, wherein the second angle range comprises angles of rotation between −60° and −50°, in particular including-50°, or between 50° and 60°, in particular including 50°.

Preferably, the following is provided: at the boundary between the first angle range and the second angle range, a first desired steering angle is determined as a function of the angle of rotation, a second desired steering angle is determined as a function of the torque, and the desired steering desired steering angle is determined as a function of the first desired steering angle and as a function of the second desired steering angle, in particular that the first desired steering angle and the second desired steering angle are mapped to the desired steering angle using a linear function.

Preferably, the desired steering angle is determined as a function of a first ratio in the first angle range and as a function of a second ratio in the second angle range, wherein the second ratio is more direct than the first ratio.

Preferably, the desired steering angle is determined as a function of a first ratio in the first angle range and as a function of a second ratio in the second angle range, wherein the second ratio is more direct than the first ratio.

The steering system for a vehicle is designed so that the steering system comprises a control element for detecting a rotation angle, wherein a torque applied by the control element is detected or provided, wherein the steering system comprises a steering actuator for moving steered wheels of the vehicle as a function of a desired steering angle, wherein the steering system is designed to determine whether the angle of rotation lies in a first angle range or a second angle range that is different from the first angle range, wherein the steering system is designed to determine the desired steering angle in the first angle range of the angle of rotation as a function of the angle of rotation, wherein the steering system is designed to determine the desired steering angle in the second angle range of the angle of rotation as a function of the torque, wherein the first angle range comprises the angle of rotation which is associated with the desired steering angle for travelling in a straight line or essentially travelling in a straight line of the vehicle, wherein the second angle range comprises an angle of rotation which is associated with a desired steering angle for a maximum steering lock of the steered wheels.

For example, the steering system is designed to determine that the angle of rotation lies in the first angle range if the angle of rotation or an amount of the angle of rotation is smaller than a threshold value, in particular smaller than 50°, or to determine that the angle of rotation lies in the first angle range if the angle of rotation or an amount of the angle of rotation is smaller than or equal to a threshold value, in particular 50°.

For example, the steering system is designed to determine that the angle of rotation lies in the second angle range if the angle of rotation or an amount of the angle of rotation is greater than or equal to a threshold value, in particular 50°, or to determine that the angle of rotation lies in the second angle range if the angle of rotation or an amount of the angle of rotation is greater than a threshold value, in particular 50°.

For example, the steering system is designed to detect an angle of rotation between −60° and 60° using the control element, wherein the first angle range includes angles of rotation between −50° and 50°, wherein the second angle range comprises angles of rotation between −60° and −50°, in particular including −50°, or between 50° and 60°, in particular including 50°.

For example, the steering system is designed to, at the boundary between the first angle range and the second angle range, determine a first desired steering angle as a function of the angle of rotation, determine a second desired steering angle as a function of the torque, and determine the desired steering angle as a function of the first desired steering angle and as a function of the second desired steering angle, in particular to map the first desired steering angle and the second desired steering angle onto the desired steering angle using a linear function.

For example, the steering system is designed to determine the desired steering angle in the first angle range as a function of a first ratio and in the second angle range as a function of a second ratio, wherein the second ratio is more direct than the first ratio.

A vehicle that comprises the vehicle's steering system has corresponding advantages.

### BRIEF DESCRIPTION OF THE DRAWINGS

Further advantageous embodiments will become apparent from the following description and the drawing. The drawings show:

FIG. 1 a schematic illustration of a vehicle, and

FIG. 2 a flowchart with steps of a method for operating a steering system of the vehicle.

### DETAILED DESCRIPTION

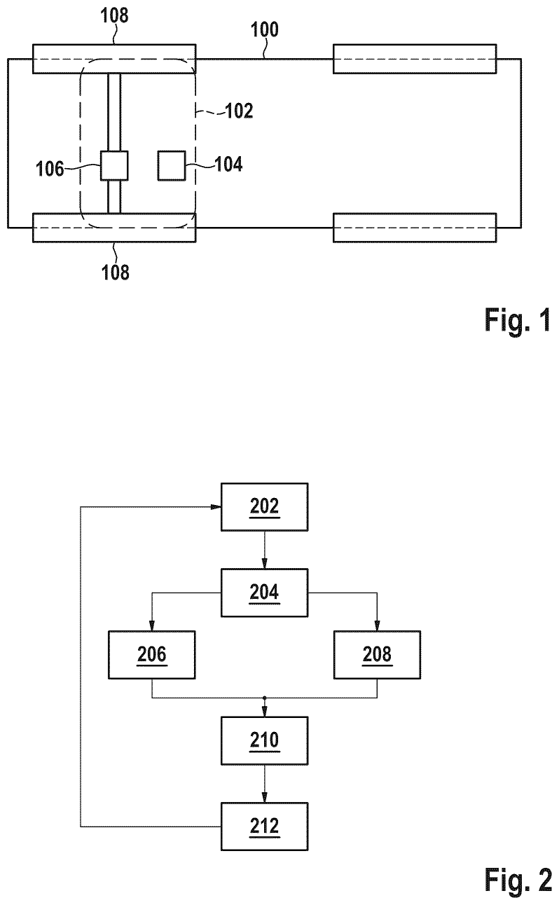

A vehicle 100 having a steering system 102 is schematically illustrated in FIG. 1. The steering system 102 is, for example, a steer-by-wire steering system.

The steering system 102 comprises a control element 104, e.g. a joystick, for detecting an angle of rotation. In addition, a torque applied by the control element 104 is detected or provided by the control element 104.

The control element 104 is designed, for example, to detect an angle of rotation between-60° and 60°.

The steering system 102 comprises a steering actuator 106 for moving steered wheels 108 of the vehicle 100 as a function of a desired steering angle.

The steering system 102 is designed to determine whether the angle of rotation lies in a first angle range or a second angle range that is different from the first angle range.

The first angle range comprises the angle of rotation that is assigned to the desired steering angle, e.g. 0°, for the vehicle 100 to travel in a straight line.

The second angle range comprises an angle of rotation that is assigned to a desired steering angle, e.g. −540° or +540°, for a maximum steering lock of the steered wheels 108.

The first angle range comprises, for example, angles of rotation between −50° and 50°. The second angle range comprises, for example, angles of rotation between −60° and −50°.

The first angle range comprises, for example, angles of rotation of exactly −50°. The second angle range comprises, for example, angles of rotation including −50°.

Other divisions of the angle ranges, e.g. with a boundary between 45° and 55°, in particular 49° or 51°, may also be provided.

The steering system 102 is designed to determine the desired steering angle in the first angle range of the angle of rotation as a function of the angle of rotation.

The steering system 102 is designed to determine the desired steering angle in the second angle range of the angle of rotation as a function of the torque.

The steering system 102 is designed, for example, to determine that the angle of rotation lies in the first angle range if an amount of the angle of rotation δ_{be} is smaller than a threshold value Schwelle_1, in particular 50°.

|δ_{be}|<Schwelle_1

The steering system 102 is designed, for example, to determine that the angle of rotation lies in the second angle range if the magnitude of the angle of rotation is greater than or equal to the threshold value Schwelle_1, in particular the threshold value of 50°.

|_{be}|≥Schwelle_1

Instead, it may be provided that the angle of rotation lies in the first angle range if the magnitude of the angle of rotation is less than or equal to the threshold value.

Instead, it may be provided that the angle of rotation lies in the second angle range if the magnitude of the angle of rotation is greater than the threshold value.

Two corresponding threshold values may be provided, one for negative angles of rotation and one for positive angles of rotation.

The steering system 102 is configured, for example, to determine the desired steering angle in the first angle range as a function of a first ratio and in the second angle range as a function of a second ratio. In the example, the second ratio is more direct than the first ratio.

For example, the steering system 102 is designed to determine the desired steering angled δ_{Rad} in the first angle range as a function of the angle of rotation δ_{be} and a vehicle longitudinal speed vₓ:

$${δ}_{Rad} = f ( {v}_{x} {δ}_{be} ) \cdot {δ}_{be}$$

wherein f(vₓδ_{be}) represents the first ratio.

For example, the steering system 102 is designed to determine the desired steering angle δ_{Rad} in the second angle range as a function of the angle of rotation δ_{be}, the torque, and the vehicle longitudinal] speed vₓ:

$${δ}_{Rad} = f ( {v}_{x} {δ}_{be} , {M}_{be} ) \cdot {M}_{be}$$

wherein f(vₓδ_{be}, M_{be}) represents the second ratio.

In one example, the steering system 102 is designed to determine a first desired steering angle as a function of the angle of rotation at the boundary between the first angle range and the second angle range, to determine a second desired steering angle as a function of the torque, and to determine the desired steering angle as a function of the first desired steering angle and as a function of the second desired steering angle.

For example, the steering system 102 is designed to map the first desired steering angle and the second desired steering angle to the desired steering angle using a linear function.

FIG. 2 schematically illustrates a method for operating the steering system 102 of the vehicle 100. The steering system 102 comprises, for example, a computing device designed to execute the method.

The method comprises a step 202.

In step 202, the control element 104 records the angle of rotation and the torque.

The angle of rotation is detected between −60° and 60°, for example.

Subsequently, a step 204 is carried out.

In step 204, it is determined whether the angle of rotation lies in the first angle range or in the second angle range.

In the example, the first angle range comprises angles of rotation between −50° and 50°. The second angle range comprises angles of rotation between −60° and −50°, including −50°, and angles of rotation between 50° and 60°, including 50°.

For example, it is determined that the angle of rotation lies in the first angle range if the absolute value of the angle of rotation is less than the threshold value.

For example, it is determined that the angle of rotation lies in the second angle range if the magnitude of the angle of rotation is greater than or equal to the threshold value.

The threshold value is, for example, 50°. Instead, another of the value range classifications described for the steering system 102 or another threshold value or another type of comparison with the threshold value may be provided.

If the angle of rotation lies in the first value range, a step 206 is executed. If the angle of rotation lies in the second value range, a step 208 is executed.

It may be provided to perform step 206 and step 208 in a region around the boundary between the value ranges.

In step 206, the desired steering angle is determined as a function of the angle of rotation in the first angle range of the angle of rotation.

In step 208, the desired steering angle is determined as a function of the torque in the second angle range of the angle of rotation.

The desired steering angle is determined as a function of the first ratio in the first angle range and as a function of the second ratio in the second angle range.

This is how an indirect steering ratio is applied to the first angle range, e.g. up to +/−50°. The indirect steering ratio is modeled on the ratio of a steering wheel, for example. The first angle range corresponds to a first desired steering angle range.

In the remaining second angle range, e.g. up to +/−60°, i.e. in a range of 10° of the angle of rotation, an increasing steering torque, for example, is generated up to a final stop torque and a remaining second setpoint steering angle range is realized as a function of the torque.

In an optional step 210, a first desired steering angle is determined as a function of the angle of rotation in the area of the boundary between the first angle range and the second angle range, and a second desired steering angle is determined as a function of the torque.

In step 210, the desired steering angle is determined as a function of the first desired steering angle and as a function of the second desired steering angle. For example, the first desired steering angle and the second desired steering angle are mapped to the desired steering angle using the linear function. This ensures that a transition between the two ranges is smooth.

Subsequently, a step 212 is carried out.

In step 212, the steered wheels 108 are steered with the steering actuator 106 as a function of the desired steering angle.

Step 202 is then carried out.

What is claimed is:

1. A method for operating a steering system of a vehicle, comprising:
detecting an angle of rotation using a control element of the steering system;
detecting a torque applied by the control element;
moving steered wheels of the vehicle as a function of a desired steering angle using a steering actuator of the steering system;
determining whether the angle of rotation lies in a first angle range or a second angle range that is different from the first angle range;
determining the desired steering angle in the first angle range of the angle of rotation as a function of the angle of rotation; and
determining the desired steering angle in the second angle range of the angle of rotation as a function of the torque,
wherein the first angle range comprises the angle of rotation associated with the desired steering angle for travelling in a straight line or essentially travelling in a straight line of the vehicle, and
wherein the second angle range comprises an angle of rotation associated with the desired steering angle for maximum steering lock of the steered wheels.

2. The method according to claim 1, further comprising:
determining that the angle of rotation lies in the first angle range when the angle of rotation or an amount of the angle of rotation is smaller than a threshold value, wherein the threshold value is 50°, or
determining that the angle of rotation lies in the first angle range when the angle of rotation or an amount of the angle of rotation is smaller than or equal to a threshold value, wherein threshold value is 50°.

3. The method according to claim 1, further comprising:
determining that the angle of rotation lies in the second angle range when the angle of rotation or an amount of the angle of rotation is greater than or equal to a threshold value, wherein the threshold value is 50°, or
determining that the angle of rotation lies in the second angle range when the angle of rotation or an amount of the angle of rotation is greater than a threshold value, wherein the threshold value is 50°.

4. The method according to claim 1, further comprising:
detecting the angle of rotation between −60° and 60° using the control element,
wherein the first angle range comprises angles of rotation between −50° and 50°, and
wherein the second angle range comprises angles of rotation from −60° to −50° or from 50° to 60°.

5. The method according to claim 1, further comprising:
determining, at a boundary between the first angle range and the second angle range, a first desired steering angle as a function of the angle of rotation, and a second desired steering angle as a function of the torque,
wherein the desired steering angle is determined as a function of the first desired steering angle and as a function of the second desired steering angle, and
wherein the first desired steering angle and the second desired steering angle are mapped to the desired steering angle using a linear function.

6. The method according to claim 1, further comprising:
determining the desired steering angle as a function of a first ratio in the first angle range and as a function of a second ratio in the second angle range,
wherein the second ratio is more direct than the first ratio.

7. A steering system for a vehicle, comprising
a control element configured to detect an angle of rotation, wherein a torque applied by the control element is detected or provided,
a steering actuator configured to move steered wheels of the vehicle as a function of a desired steering angle,
wherein the steering system is configured to determine whether the angle of rotation lies in a first angle range or a second angle range that is different from the first angle range,
wherein the steering system is configured to determine the desired steering angle in the first angle range of the angle of rotation as a function of the angle of rotation,
wherein the steering system is configured to determine the desired steering angle in the second angle range of the angle of rotation as a function of the torque,
wherein the first angle range comprises the angle of rotation associated with the desired steering angle for travelling in a straight line or essentially travelling in a straight line of the vehicle, and
wherein the second angle range comprises an angle of rotation associated with a desired steering angle for a maximum steering lock of the steered wheels.

8. The steering system according to claim 7, wherein:
the steering system is configured to determine that the angle of rotation lies in the first angle range when the angle of rotation or an amount of the angle of rotation is smaller than a threshold value, wherein the threshold value is 50°, or
the steering system is configured to determine that the angle of rotation lies in the first angle range when the angle of rotation or an amount of the angle of rotation is smaller than or equal to a threshold value, wherein the threshold value is 50°.

9. The steering system according to claim 7, wherein:
the steering system is configured to determine that the angle of rotation lies in the second angle range when the angle of rotation or an amount of the angle of rotation is greater than or equal to a threshold value, wherein the threshold value is 50°, or
the steering system is configured to determine that the angle of rotation is in the second angle range when the angle of rotation or an amount of the angle of rotation is greater than a threshold value, wherein the threshold value is 50°.

10. The steering system according to claim 7, wherein:
the steering system is configured to detect an angle of rotation between −60° and 60° using the control element,
the first angle range comprises angles of rotation between −50° and 50°, and
the second angle range comprises angles of rotation from −60° to −50° or from 50° to 60°.

11. The steering system according to claim 7, wherein the steering system is configured to determine a first desired steering angle at a boundary between the first angle range and the second angle range as a function of the angle of rotation, to determine a second desired steering angle as a function of the torque, and to determine the desired steering angle as a function of the first desired steering angle and as a function of the second desired steering angle, by mapping the first desired steering angle and the second desired steering angle onto the desired steering angle using a linear function.

12. The steering system according to claim 7, wherein:
the steering system is configured to determine the desired steering angle in the first angle range as a function of a first ratio and in the second angle range as a function of a second ratio, and
the second ratio is more direct than the first ratio.

13. A vehicle comprising:
the steering system according to claim 7.
